(19) United States
(12) Patent Application Publication
(10) Pub. No.: US 2025/0027609 A1
(43) Pub. Date: Jan. 23, 2025

(54) CRYOGENIC VESSEL ARRANGEMENT

(71) Applicant: Fabrum IP Holdings Limited, Christchurch (NZ)

(72) Inventors: Christopher Patrick BOYLE, Christchurch (NZ); Richard Hugh REYNOLDS, Christchurch (NZ)

(21) Appl. No.: 18/716,711

(22) PCT Filed: Dec. 5, 2022
(86) PCT No.: PCT/IB2022/061752

§ 371 Date: Jun. 5, 2024

(30) Foreign Application Priority Data
Dec. 9, 2021 (NZ) 783316

(51) Int. Cl. F17C 3/08

(52) U.S. Cl. CPC F17C 3/08; F17C 2203/0345; F17C 2203/0604; F17C 2203/0631; F17C 2203/0639; F17C 2203/0646; F17C 2203/0648; F17C 2203/0673; F17C 2205/0332; F17C 2223/0161

(57) ABSTRACT

A cryogenic vessel arrangement 100 for storage of cryogenic liquids, the arrangement comprising a liner member 30 spaced inwardly and apart from an inner wall 24 of the vessel arrangement, the inner wall 24 defining a containment volume 28 of the vessel arrangement internally of the inner wall 24, the liner member 30 located within said containment volume 28 and configured to receive and contain a cryogenic liquid 30A, wherein a thermal capacitance of the liner member 30 is substantially less than that of the inner wall 24.

### FIELD OF THE INVENTION

This invention relates to a cryogenic vessel arrangement for storage of cryogenic liquids as well as cryogenic vessel liner for use in cryogenic vessels.

This application claims priority from New Zealand patent application number 783316 filed 9 Dec. 2021, the entire contents of which are hereby incorporated by way of reference.

### BACKGROUND

Cryogenic liquids or cryogens are liquefied gases used in the art in their liquid state at very low temperatures. They are often stored in cryogenic liquid storage systems that are widely used for the general storage of cryogens, cryogenic fuel tanks, superconducting applications and other applications, often for cooling.

These cryogenic liquid storage systems will generally comprise an inner storage volume for the cryogenic liquid that is then surrounded with insulating material. In some cases, this insulating material can be a vacuum space containing multilayer insulation, and is often itself surrounded by an outer vacuum shell.

Whenever these cryogenic liquid storage systems, or cryogenic vessels, are filled from a warm (room temperature) state, the inner storage volume must first be cooled down from said room temperature to the temperature of the cryogen. The vessel must therefore be made from materials and/or otherwise designed to accommodate the sudden and large change in temperature (thermal shock), or must be filled very slowly.

In the first case, thermal shock may present a range of issues for conventional materials and vessel design, as the sudden contraction or expansion of materials upon a rapid temperature change often results in development of stresses that exceed the strength of said material. This may cause distortion or buckling, and in composite materials may cause interlaminar sheer, with associated propagation of fractures or cracks in the vessel. It may also result in a high rate of initial boil-off of the cryogenic liquid. In the latter case, slow filling of cryogenic liquid of course results in down-time and slows transport and filling activities associated with cryogenic vessels. In either case, costs are incurred either in complex/high-cost materials vessel design/manufacture and/or down-time.

Thus, there is a need in the art of cryogenic vessels to provide an arrangement therefor that reduces the issues associated with thermal shock, reduces the initial rate of boil off of cryogens when first filling a vessel from less than fully cold conditions, and reduces the rate at which the inner storage volume gains temperature after being drained of said cryogens (to mitigate thermal shock in subsequent filling).

In this specification where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

It is therefore an object of at least preferred embodiments of the present invention to provide a cryogenic vessel arrangement and/or cryogenic vessel liner for use in cryogenic vessels, that at least ameliorates some of the above mentioned issues associated with conventional cryogenic vessel design and/or to at least provide the public with a useful alternative.

### SUMMARY OF THE INVENTION

In accordance with a first aspect of the invention, there is provided a cryogenic vessel arrangement for storage of cryogenic liquids, the arrangement comprising: an outer wall defining an external periphery of the vessel arrangement; an inner wall spaced inwardly from said outer wall so as to define therebetween an insulation volume of the vessel arrangement, wherein the inner wall defines a containment volume of the vessel arrangement internally of the inner wall; and a liner member spaced inwardly and apart from the inner wall and located within said containment volume, the liner member configured to receive and contain a cryogenic liquid, wherein a thermal capacitance of the liner member is substantially less than that of the inner wall.

In some embodiments, the thermal capacitance of the liner member is configured so as to substantially reduce or inhibit a rate at which cryogenic vapours are released by the cryogenic liquid upon its contact with, or receipt or storage by, the liner member.

In some embodiments, the thermal capacitance of the liner member is configured so as to substantially reduce or inhibit a rate at which the temperature of the liner member rises upon departure of cryogenic liquid therefrom.

In some embodiments, the liner member is configured with a thickness that ranges from about ⅓rd to about 1/10th of a thickness of the inner wall.

In some embodiments, the inner wall has a thickness about 5 mm to about 10 mm.

In some embodiments, the liner member has a thickness of about 0.5 mm to about 2 mm.

In some embodiments, the liner member comprises at least one material selected from: metal, metal alloys, steel, steel alloys, aluminium, composites, fibreglass composites, fibreglass laminates, glass polymers, fibre-reinforced plastics and/or G-10 fibreglass laminate.

In some embodiments, the liner member comprises G-10 fibreglass laminate.

In some embodiments, the liner member has a thermal conductivity that ranges from about 0.25 W/m-K to about 240 W/m-K.

In some embodiments, the liner member has a thermal conductivity of about 0.288 W/m-K.

In some embodiments, the liner member is configured to receive and contain the cryogenic liquid in a manner so as to substantially reduce or inhibit contact of the cryogenic liquid with the containment volume and/or inner wall.

In some embodiments, the liner member is spaced apart from the inner wall and located within said storage volume by support member(s) that operatively connect said liner member to said inner wall.

In some embodiments, the liner member is configured to be spaced apart from the inner wall at a distance that ranges from about 3 to about 20 times a thickness of the liner member.

In some embodiments, the containment volume is configured to entrap at least some cryogenic vapours released by the cryogenic liquid upon its contact with, or receipt or storage by, the liner member.

In some embodiments, the liner member and/or inner wall is/are configured such that the containment volume substantially maintains a pressure equilibrium between cryogenic liquids received or stored by the liner member and cryogenic vapours released by the cryogenic liquid upon its contact with, or receipt or storage by, the liner member.

In some embodiments, said pressure equilibrium is substantially maintained via release, out from the containment volume, of at least some of said cryogenic vapours released by the cryogenic liquid upon its contact with, or receipt or storage by, the liner member.

In some embodiments, said pressure equilibrium is substantially maintained via release, out from the containment volume, of at least some of said cryogenic vapours out from the liner member and/or containment volume by relief member(s) arranged at the inner wall and/or liner member.

In some embodiments, said relief member(s) comprise(s) aperture(s), valve(s) and/or port(s).

In some embodiments, the containment volume is configured to receive or store a gas maintained at substantially the same pressure as the cryogenic liquids received or stored by the liner member.

In some embodiments, said gas comprises hydrogen gas.

In some embodiments, the insulation volume is configured to contain or comprises a vacuum and one or more insulative materials comprising multi-layer insulation, microspheres, polyester film(s), silk netting(s) and/or nylon netting(s).

In some embodiments, the insulation volume is configured to have a surface area heat leak that ranges from at least about 0.5 W/m² to about 20 W/m².

In a second aspect of the present invention, there is provided a cryogenic vessel comprising the cryogenic vessel arrangement of the first aspect and/or of any of the aforementioned embodiments.

In a third aspect of the present invention, there is provided a cryogenic vessel liner for use in cryogenic vessels, the liner configured to be located within a containment volume of a cryogenic vessel the periphery of which is defined by a vessel wall, wherein the liner is configured to receive and contain a cryogenic liquid and is configured to be spaced inwardly and apart from said vessel wall in a manner so as to substantially reduce or inhibit contact of the cryogenic liquid with the containment volume and/or vessel wall in use, and wherein the liner has a thermal capacitance that substantially reduces or inhibits a rate at which cryogenic vapours are released by the cryogenic liquid upon its contact with, or receipt or storage by, the liner in use.

In some embodiments, the liner is configured with a thermal capacitance that substantially reduces or inhibits a rate at which the temperature of the liner rises upon departure of cryogenic liquid from the liner.

In some embodiments, the liner has a thickness of about 0.5 mm to about 2 mm.

In some embodiments, the cryogenic vessel liner further comprises support member(s) to support said liner from said vessel wall.

In some embodiments, the support member(s) is/are configured such that the liner is configured to be spaced apart from the vessel wall at a distance that ranges from about 3 to about 20 times a thickness of the liner.

In some embodiments, the liner comprises at least one material selected from: metal, metal alloys, steel, steel alloys, aluminium, composites, fibreglass composites, fibreglass laminates, glass polymers, fibre-reinforced plastics and/or G-10 fibreglass laminate.

In some embodiments, the liner comprises G-10 fibreglass laminate.

In some embodiments, the liner has a thermal conductivity that ranges from about 0.25 W/m-K to about 240 W/m-K.

In some embodiments, the liner has a thermal conductivity of about 0.288 W/m-K.

In a fourth aspect of the present invention, there is provided a cryogenic vessel comprising the cryogenic vessel liner of the third aspect and/or of any of the aforementioned embodiments.

In a fifth aspect of the present invention, there is provided a cryogenic vessel for storage of cryogenic liquids, the vessel comprising: a containment volume the periphery of which is defined by a vessel wall; and the cryogenic vessel liner of the third aspect and/or of any of the aforementioned embodiments located within the containment volume and spaced inwardly and apart from said vessel wall.

In some embodiments, the liner is configured such that its thermal capacitance is substantially less than that of the vessel wall.

In some embodiments, the liner is configured with a thickness that ranges from at least about ⅓rd to about 1/10th of a thickness of the vessel wall.

One of more statements above relating to the first aspect may also apply to the third, fourth and/or fifth aspect.

The term ‘comprising’ as used in this specification and claims means ‘consisting at least in part of’. When interpreting statements in this specification and claims which include the term ‘comprising’, other features besides the features prefaced by this term in each statement can also be present. Related terms such as ‘comprise’ and ‘comprised’ are to be interpreted in a similar manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

This invention may also be said broadly to consist in the parts, elements and features referred to or indicated in the specification of the application, individually or collectively, and any or all combinations of any two or more said parts, elements or features.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting. Where specific integers are mentioned herein which have known equivalents in the art to which this invention relates, such known equivalents are deemed to be incorporated herein as if individually set forth.

As used herein the term ‘(s)’ following a noun means the plural and/or singular form of that noun.

As used herein the term ‘and/or’ means ‘and’ or ‘or’, or where the context allows both.

The invention consists in the foregoing and also envisages constructions of which the following gives examples only.

### BRIEF DESCRIPTION OF THE DRAWINGS

The present invention will now be described by way of example only and with reference to the accompanying drawings in which:

FIG. 1 shows a prior art cryogenic vessel;

FIG. 2 shows a cryogenic vessel of an embodiment of the disclosure; and

FIG. 3 shows an alternative cryogenic vessel of an embodiment of the disclosure.

### DETAILED DESCRIPTION OF EMBODIMENTS

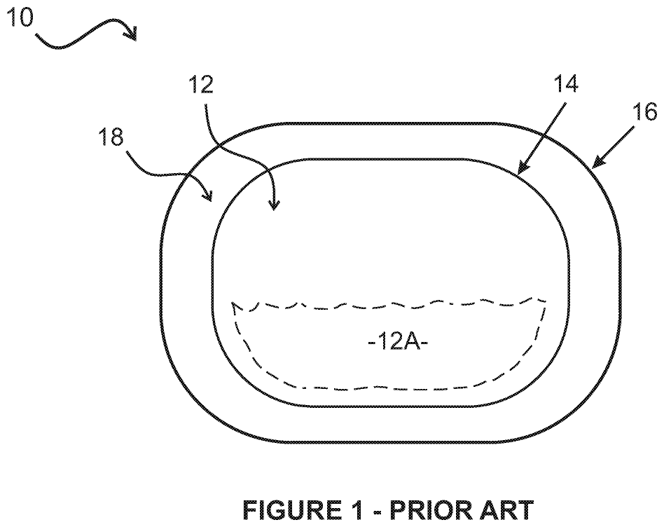

An example of a prior art cryogenic vessel is shown in FIG. 1. Here, the prior art vessel is indicated generally by the numeral 10, and may generally comprise of an inner containment volume 12 for the cryogenic liquid 12A that is then surrounded with a vessel wall 14 and an outer shell 16 external thereof, between which may be found any suitable insulating arrangement 18 known in the art.

Since the cryogenic liquid 12A therein is contained directly by the vessel wall 14, this vessel wall 14 must bear the burden of accounting for the effects associated with the extreme temperature of the cryogenic liquid 12A, said effects including thermal shock, excessive initial boil-off of the cryogenic liquid 12A and resulting down time during filling/dispensing of said liquid 12A to mitigate said effects. Thus, the vessel wall 14 (and often also the outer shell 16) must be made from materials and/or otherwise designed to accommodate the sudden and large change in temperature, while also performing the duties of pressure maintenance and temperature insulation. This results in complex and costly vessel designs.

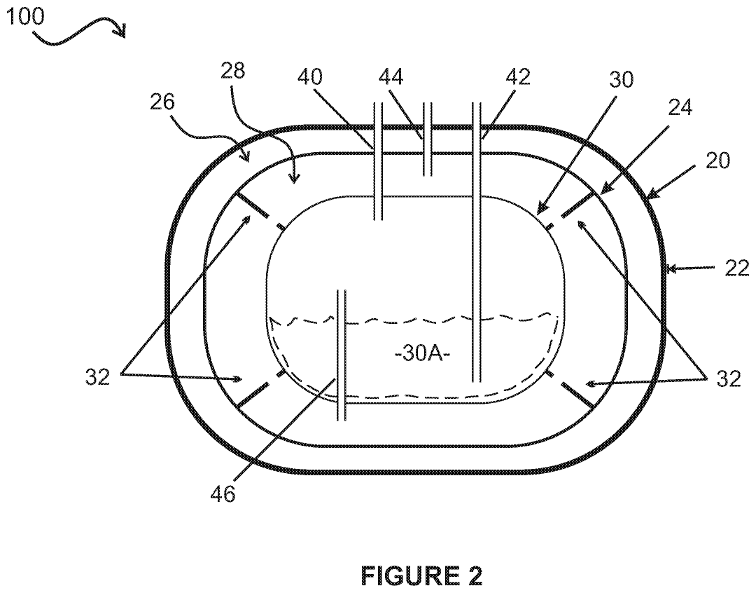

An embodiment of a cryogenic vessel arrangement for storage of cryogenic liquids will now be described with reference to FIG. 2. The cryogenic vessel arrangement is generally indicated by the numeral 100. Here, this exemplary embodiment of the cryogenic vessel arrangement 100 takes the form of a cryogenic fuel tank suitable for the storage and dispensing of, for example, cryogenic hydrogen or methane used in cryogenic fuel applications (such as for vehicles and the like).

As can be seen in FIG. 2, the cryogenic vessel arrangement 100 may generally comprise of an outer wall 20 defining an external periphery 22 of the vessel arrangement 100.

It will be appreciated that a skilled person may arrange further layers, wall, features or elements of a given vessel arrangement external this outer wall 20. However, the external periphery 22 defined thereby generally refers to the outermost extent of the features of the cryogenic vessel arrangement 100 described herein that together may provide the principal functions of temperature insulation as well as reduction/mitigation of temperature changes, thermal shock and the like described in further detail below.

Thus, the term ‘arrangement’ as used herein shall be understood to refer to an exemplary configuration of a cryogenic vessel so as to provide the above functions, and does not exclude additional modifications, features or elements that may be desired for a particular application of a cryogenic vessel. The same reasoning may also apply to features of the cryogenic vessel arrangement 100 in addition to those described below that are disposed inward of said outer wall 20/external periphery 22.

The cryogenic vessel arrangement 100 may generally also comprise of an inner wall 24 spaced inwardly from said outer wall 20 so as to define therebetween an insulation volume 26 of the cryogenic vessel arrangement 100. This insulation volume 26 will be described in further detail below but generally acts to insulate the contents of the cryogenic vessel from the environment and associated temperatures external the cryogenic vessel arrangement 100.

The inner wall 24 defines a containment volume 28 of the vessel arrangement 100 internally of the inner wall 24. This containment volume 28 will be described in further detail below but generally serves to contain the cryogenic liquids and associated vapours, and also serves to constrain, control and/or define in part the associated temperatures, pressures and other properties imparted onto the cryogenic vessel by the cryogenic liquids, once received thereby.

The cryogenic vessel arrangement 100 further comprises a liner member 30 spaced inwardly and apart from the inner wall 24 and located within said containment volume 28. This liner member 30 is principally configured to receive and contain the cryogenic liquid, and may be intended as the exclusive feature of the vessel arrangement 100 that does so. In this manner, the liner member 30 substantially reduces or inhibits contact of the cryogenic liquid with the containment volume 28 and/or inner wall 24, whether during filling, during storage/transport, or during disposal of the liquid from the vessel 100. FIG. 2 shows an example volume of cryogenic liquid 30A contained within the liner member 30.

The thermal capacitance of the liner member 30 is substantially less than that of the inner wall 24.

Thermal capacitance may be defined generally as the heat or temperature input necessary to change the temperature of a medium. In other words, it more generally reflects the amount of influence external temperature input has on the internal temperature of a given medium, or how readily a medium accepts temperature input.

In this case, the liner member 30 may be configured so that its thermal capacitance is significantly lower than that of the inner wall 24 of the cryogenic vessel arrangement 100.

Because thermal capacitance is an extensive property of a medium (i.e., dependent on both internal material properties as well as external mass, size, volume etc.), the liner member 30 may be configured to have a low thermal capacitance relative the inner wall 24 in a number of ways.

In one configuration, the liner member 30 is configured with a thickness that ranges from about ⅓^{rd} to about 1/10^{th} of a thickness of the inner wall 24. For example, for a given cryogenic vessel arrangement 100 having a cryogenic liquid storage volume capacity of about 500 litres to about 1000 litres, the inner wall 24 may have a thickness of about 5 mm to about 10 mm, with the liner member having a thickness of about 0.5 mm to about 2 mm. At larger vessel volumes, exceeding 1000 litres, the liner member 30 may, for example, have a thickness of anywhere from about 0.5 mm to about 5 mm, but may be less than about 6 mm.

Those skilled in the art may scale the thickness of the liner member 30 relative the thickness of the inner wall 24, in accordance with storage pressures, liquid density, design accelerations, as well as the material(s) chosen to form said liner member 30, inner wall 24 and outer wall 20. Those skilled in the art will further appreciate that a wide range of relative thicknesses may be possible, as long as the liner member 30 is substantially thinner than the inner wall 24.

Minimising the thermal capacitance of the liner member 30 is advantageous as it provides for the following benefits:
Reduced or mitigated thermal shock: By having a low thermal capacitance, the liner member 30 will more readily accept a temperature input. By having a low thickness (substantially lower than that of the inner wall 24), the thermal gradient of the liner member 30 (the difference in temperature at one face/end of the liner member relative the opposing face/end of the liner member, i.e., the temperature difference across its thickness) is significantly reduced. Since the temperature gradient is minimal, the liner member 30 will thermally contract uniformly across its thickness, and thus is less likely to experience a difference in tensile stress at one part or portion thereof relative another which difference may result in rapid uneven distortion, buckling and thus associated structural failure or weakness. This is especially advantageous when composite materials are chosen for the liner member 30, such composites being particularly susceptible to interlaminar shear and associated propagation of fractures or cracks. Further, in being relatively thin compared to the inner wall 24, the liner member 30 is able to thermally contract without imparting large loads on the often heavier and stronger inner wall 24.
Reduced or mitigated initial boll-off: Because the liner member 30 has a substantially lower thermal capacitance compared to the inner wall 24, less of the cryogenic liquid will boil-off or vaporise from its liquefied state upon contact with the liner member 30. A further advantage may arise from limiting initial boil-off of the cryogenic vapours, in that it will be easier to capture and reliquefy said boil-off cryogenic vapours, which may be useful in applications where the cryogenic vessel arrangement 100 is used as a large storage vessel or a vehicle fuel tank.
Reduced or mitigated rate in the rise of temperature after emptying: Once the cryogenic vessel arrangement 100 is emptied of its cryogenic liquid, the temperature rise back to room temperature is more gradual. Thus, the liner member 30 will generally remain at a low temperature for longer. Thus, upon subsequent re-filling of the cryogenic vessel arrangement 100, the temperature difference between the liner member 30 and a new supply of cryogenic liquid may be minimal or at least lower than during the initial filling of the vessel, further mitigating thermal shock and initial boil-off.

Thus, the thermal capacitance of the liner member 30 may be configured so as to substantially reduce or inhibit the rate at which cryogenic vapours are released by the cryogenic liquid 30A upon its contact with, or receipt or storage by, the liner member 30. Further, the thermal capacitance of the liner member 30 may be configured so as to substantially reduce or inhibit the rate at which the temperature of the liner member 30 rises upon departure of cryogenic liquid 30A therefrom.

Compared to a conventional vessel 10 of FIG. 1 where no liner member 30 is present and the wall thickness of the vessel wall 14 is about 5 mm to 10 mm, the example embodiment above may achieve an 80% reduction in overall thermal mass, or thermal capacitance, in the cryogenic vessel arrangement 100 relative thereto. This 80% reduction in overall thermal mass may be directly proportional to an 80% reduction in initial boil-off of the cryogenic liquid 30A.

The above reductions in thermal shock and rise in temperature after emptying also allow for a more consistent fill procedure, without the down-time associated with slow-filling conventional vessel arrangements such as those of FIG. 1. Compared to a conventional vessel, such as that of FIG. 1 where no liner member 30 is present, the cryogenic vessel arrangement 100 herein may provide for near-instantaneous filling and emptying, whereas conventional vessels may require anywhere from about 30 minutes to about 60 minutes or longer for filling depending on the vessel size, application, and volume/capacity.

Further, those skilled in the art will appreciate that the liner member 30 may (in addition, or as an alternative to being thinner than the inner wall 24) also be composed of materials different to those of said inner/outer walls 20, 24 having inherently lower thermal capacitance properties (i.e., having lower specific thermal capacities, the intensive equivalent of thermal capacity).

Generally, however, irrespective of materials chosen, the lower thickness of the liner member 30 relative the inner wall 24 may, in some configurations, remain the primary way of reducing its thermal capacitance relative thereto.

In this manner, the cryogenic vessel arrangement 100 (specifically its inner/outer walls 20, 24) may be designed and manufactured from common materials, such as metal or metal alloys, (steel, steel alloys, stainless steel, aluminium etc.) with the liner member 30 similarly composed for ease of manufacture and design, but simply be made significantly thinner than the inner wall 24 to achieve said relatively lower thermal capacitance.

In other embodiments, the liner member 30 may comprise composites, fibreglass composites, fibreglass laminates, glass polymers, fibre-reinforced plastics and the like.

For example, the liner member 30 may in some configurations comprise G-10 fibreglass laminate having a thermal conductivity of about 0.288 W/m-K.

In some embodiments, the liner member 30 may have a thermal conductivity that ranges from about 0.25 W/m-K to about 240 W/m-K.

Thermal conductivity may be understood as a measure of a material's ability to conduct heat. Generally, having a higher thermal conductivity will result in quicker and more ready heat transfer. Unlike thermal capacitance, which may be dependent on the external properties of a medium (mass, volume, thickness etc.), thermal conductivity is material-dependent. Thus, those skilled in the art will understand that the liner member 30 may be configured with a low thermal capacitance (by for instance making the liner member 30 substantially thin) while also having a high thermal conductivity (by choosing materials appropriately).

While conventional metal or metal alloys may have higher thermal conductivities, (i.e., steel has a much higher thermal conductivity of about 45 W/m-K, and aluminium of about 240 W/m-K), use of composites such as G-10 fibreglass laminate provides advantages particularly applicable to the liner member 30, in that G-10 fibreglass laminate exhibits advantageous physical properties such as high strength-to-weight ratio (which are advantageous given the low thickness and thus mass/volume of the liner member 30), as well as high strength and consistent dimensional stability over a range of temperatures.

Thus, it will be appreciated that while use of conventional metal or metal alloys may be suitable for the liner member 30 in some embodiments (especially where the same or similar materials are used of the inner and outer walls 20, 24), selection of composites in particular (such as G-10 fibreglass laminate) as the material for the liner member 30 provides at least the above advantages over conventional metal or metal alloys. However, due to composites being particularly susceptible to interlaminar shear and associated propagation of fractures or cracks, configuring the liner member 30 to have a low thickness (i.e., substantially lower than that of the inner wall 24) yields a synchronous or harmonious benefit in reducing the thermal gradient of the liner member 30 and thus the likelihood of said interlaminar shear and associated propagation of fractures or cracks, as described above.

In any case, a person skilled in the art may configure the liner member 30 in a number of ways to achieve a thermal capacitance thereof that is substantially lower than that of the inner wall 24.

In this way, the cryogenic vessel arrangement 100 may provide the benefits mentioned above through provision of an inner liner member 30:
spaced apart from the other walls of the vessel so as to isolate the cryogenic liquids from the other walls or elements of the vessel, and
further configured with a low thermal capacitance relative the inner wall 24, to thereby:
reduce the thermal shock and other undesirable effects imparted upon the vessel walls of conventional vessel arrangements (such as that of FIG. 1) where no liner member is present and the cryogenic liquids are stored within/against the vessel walls 14, 16 themselves, thus said walls 14, 16 having to bear said undesirable effects themselves while also being configured to perform other functions of insulation and the like.

Thus, provision of a liner member 30 as described above greatly reduces the complexity of material demands imparted on a cryogenic vessel, since the liner member 30 alone bears the dedicated burden of direct contact with the cryogenic liquid and dealing with the associated effects thereof, allowing the inner/outer walls 20, 24 to be designed to only account for pressure maintenance and temperature insulation.

In some embodiments, the liner member 30 is configured to be spaced apart from the inner wall 24 at a distance that ranges from about 3 to about 20 times a thickness of the liner member 30. In other words, for the example configuration above (of a vessel with a liquid storage capacity of about 500 litres to about 1000 litres; an inner wall 24 of 5 mm to 10 mm thickness; and a liner member 30 of 0.5 mm to 2 mm thickness), the liner member 30 may be spaced apart from the inner wall 24 by about 3 mm to about 20 mm.

The liner member 30 may be spaced apart from the inner wall 24 and located within said storage volume 28 by support member(s) 32 that operatively connect said liner member 30 to said inner wall 24. These are shown in FIG. 2 and may comprise of any number of support or suspension members known in the art of cryogenic vessel design, such as, for example: metal or composite hangers/flanges, tensile suspension members (cables etc.) and the like. In some configurations, where the material(s) chosen for the liner member 30 and inner wall 24 allow, the support member(s) 32 may be glued or welded to both the liner member 30 and inner wall 24 so as to operatively connect the two.

The support member(s) 32 may be configured through either material selection or physical configuration (thickness, size etc.) to also minimise the amount of thermal transfer passing from the liner member 30 to the inner wall 24. Any number of support member(s) 32 may be provided as necessary to appropriately space the liner member 30 apart from the inner wall 24, as long as they together provide sufficient support for the liner member 30 so as to allow it to accommodate gravitational and inertial loads during transport of the cryogenic vessel arrangement 100. The chosen thickness of the liner member 30 may be influenced by the number of and configurations of the support member(s) 32.

In some embodiments, such as the fuel tank application of the cryogenic vessel arrangement 100 embodiment of FIG. 2, the liner member 30 may be of a fully closed arrangement, such that it continues to isolate/contain the cryogenic liquid 30A from the inner wall 24/containment volume 28 when said liquid sloshes due to external motion.

In some embodiments, it may be advantageous that the inner and outer walls 20, 24 exhibit some level of flexibility, ideally, being only semi-rigid in structure. Likewise, it may be advantageous the liner member 30, which may be configured with a low thickness, also be flexible/non-rigid, or at least have some flexible surfaces. However, the liner member 30, inner and outer walls 20, 24 may all be rigid in some embodiments, depending on the desired application of the cryogenic vessel arrangement 100.

FIG. 2 also shows various ports of the cryogenic vessel arrangement 100, some of which may be typical in the art of cryogenic vessel arrangements. For instance, there is provided a fill port 40, extending from external the outer wall 20 into the liner member 30, to facilitate filling the liner member 30 with cryogenic liquid. There is also provided an exit port 42 extending from a location near the bottom of the liner member 30 to external the outer wall 20, to facilitate dispensing of the cryogenic liquid 30A out from the vessel arrangement 100. Any number of fill or exit ports may be provided and the substantially uniform vertically oriented port arrangements shown are exemplary only.

There is also shown a vapour port 44, extending from an outer region of the containment volume 28 to a location external the outer wall 20, to facilitate dispensing of cryogenic vapours from out the containment volume 28. In some applications, (such as that of a cryogenic fuel tank) it may be advantageous that cryogenic gaseous vapour is dispensed, in which case said vapour port 44 facilitates such. However, in this case, the vapour port 44 may facilitate vapour dispensing for that end as well as to simply reduce the amount of cryogenic vapour (and thus internal pressure) within the containment volume 28.

The containment volume 28 may be configured to entrap at least some cryogenic vapours released by the cryogenic liquid 30A upon its contact with, or receipt or storage by, the liner member 30. While the liner member 30 has a low thermal capacitance to reduce initial boil-off, it is understood that some cryogenic vapour will still be emitted by the liquid upon its entry into the vessel arrangement 100, or in general during its storage in the liner member 30. In some cases, this is advantageous or expected in certain cryogenic vessel applications.

Further, the liner member 30 and/or inner wall 24 may be configured such that the containment volume 28 substantially maintains a pressure equilibrium between cryogenic liquids 30A received or stored by the liner member 30 and cryogenic vapours released by the cryogenic liquid upon its contact with, or receipt or storage by, the liner member 30.

This pressure equilibrium may be substantially maintained via release, out from the containment volume 28, of at least some of said cryogenic vapours released by the cryogenic liquid 30A upon its contact with, or receipt or storage by, the liner member 30. This may be through the vapour port 44 described above.

Alternatively, or additionally, the pressure equilibrium may be substantially maintained via release, out from the containment volume 28, of at least some of said cryogenic vapours out from the liner member 30 and/or containment volume 28 by way of relief member(s) arranged at the inner wall 24 and/or liner member 30. The vapour port 44 described above may constitute one of these relief members.

Further, liner member port 46, shown extending from within the liner member 30 at a location above the volume of cryogenic liquid 30A to a location within the containment volume 28, may also constitute one of these relief members. In that case, the liner member port 46 acts to relieve internal pressure within the liner member 30 out to the containment volume 28, to assist in maintaining pressure equilibrium between inside the liner member 30 and its surrounding area (being the containment volume 28 external the liner member 30). The liner member port 46 may also be configured to re-direct cryogenic vapours to the containment volume 28, to assist in increasing the rate of vapour cooling of the inner wall 24.

Additional to the vapour port 44 or liner member port 46, other relief member(s) may be provided at the liner member 30 (extending out therefrom and into the containment volume 28) or at the inner wall 24 (extending out therefrom to external the vessel arrangement 100) to enable maintaining said pressure equilibrium. Said relief member(s) may comprise passive aperture(s) or actuatable valve(s) and/or port(s), as could be envisaged by a person skilled in the art.

In embodiments where the liner member 30 has at least some flexible surfaces, the pressure external to the liner member 30 may be increased in order to assist decanting of the cryogenic liquid 30A.

In some embodiments, the containment volume 28 may be configured to receive or store gas (such as hydrogen gas, when said cryogenic liquid 30A comprises cryogenic hydrogen) that is maintained at substantially the same pressure as the cryogenic liquids 30A received or stored by the liner member 30 (and may be of the same molecule type as the cryogenic liquid 30A, as above). This may allow the liner member 30 to operate without needing to accommodate pressure loads.

Further, after receipt of cryogenic liquid 30A, the gradual and longer thermal transient or gradient experience by the liner member 30 (thanks to its low thermal capacitance as described above) allows for steady-state engagement of the cryogenic liquid in applications where said liquid is used as a fuel (i.e., where the vessel arrangement 100 is used as a fuel cell for vehicle). During which, the vapour port 44 may be utilised to dispense cryogenic vapours at a steady sufficient rate so as to maintain the desired or required maximum internal pressure (i.e., pressure equilibrium) of the containment volume 28.

Turning now to the insulation volume 26, the insulation volume 26 generally may comprise or make use of any appropriate insulation mechanism known in the art, and will generally determine the overall thermal transfer from the environment external the cryogenic vessel arrangement 100 to the cryogenic liquid 30A therein. The insulation volume 26 may also be configured to provide the level of insulation required in steady-state conditions (i.e., once the pressure and temperatures in the containment volume 28 reach equilibrium) at which point heat transfer from the external environment to the cryogenic liquid 30A is largely dominated by conventional convection and/or conduction.

For instance, the insulation volume 26 may be configured to contain or comprise a vacuum space between the inner and outer walls 20, 24 for the purpose of insulation. In addition, the insulation volume 26 comprising the vacuum space may be configured to contain or comprise one or more insulative materials.

An example insulative arrangement for the insulation volume 26 may be that of a plurality of microspheres known in the art of cryogenic vessels, a thick foam arrangement known in the art of cryogenic vessels and/or a multi-layer vacuum jacket insulation arrangement known in the art of cryogenic vessels, where multiple layers of insulative material(s) (such as polyester film(s), silk netting(s) and/or nylon netting(s)) are densely embedded into a vacuum annulus or jacket space between said inner and outer walls 20, 24.

The insulation volume 26 may be configured to have a surface area heat leak that ranges from at least about 0.5 W/m² to about 20 W/m². However, those skilled in the art may envisage other ranges of heat leak per surface area depending on a configuration of the cryogenic vessel arrangement 100.

Appropriate insulation will allow the cryogenic vapours to be dispensed (via vapour port 44, for instance) in applications where such is desired (fuel cell arrangements) at desirably low temperatures so as to make use of the cryogenic vapours thermal capacity to act a cooling agent for a fuel cell.

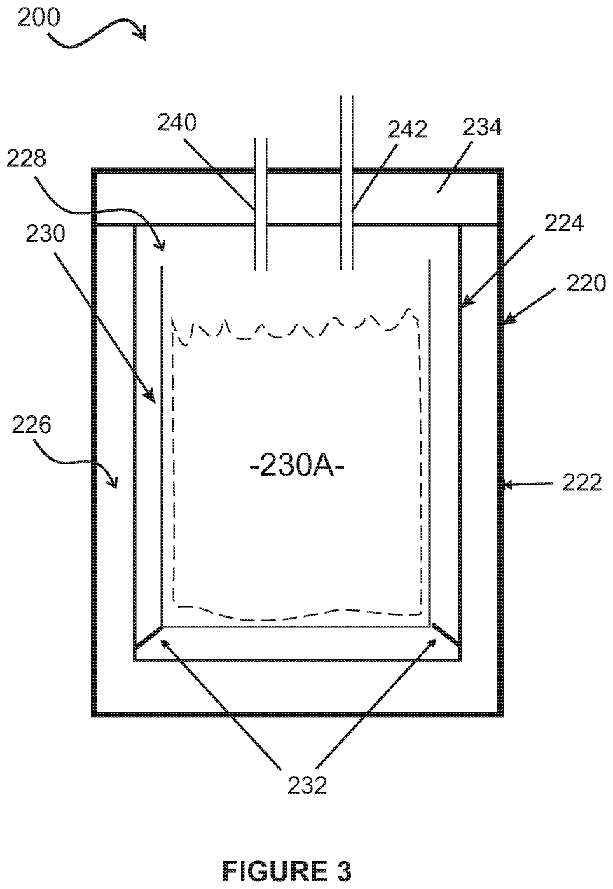

FIG. 3 shows an exemplary embodiment of the cryogenic vessel arrangement described above, but in use in a cryogenic flask application, such as for cryogenic dewars used to contain and cool superconducting coils.

In this embodiment, there is shown a cryogenic vessel arrangement 200 largely comprising of many of the same features of the cryogenic vessel arrangement 100 described above, where like parts are indicated with the same reference numerals with the addition of 200, such as an outer wall 220, external periphery 222, inner wall 224, liner member 230, insulation space 226, containment volume 228, support member(s) 232 and fill port 242.

Notable differences are shown relevant to the particular application of this cryogenic vessel arrangement 200, where the liquid exit port 242 may also serve the purpose of the vapour port 44 of the cryogenic vessel arrangement 100 described above (since in this application, cryogenic vapours are not used specifically, but may be vented to achieve pressure equilibrium within the containment volume 228, as described above).

In some configurations, the liquid exit port 242 may be extended into the cryogenic liquid 230A, and optionally substantially to the bottom of the liner member 230, if the cryogenic liquid 230A is to be emptied from the cryogenic vessel arrangement 200.

There is also provided an insulation lid 234 as required for such cryogenic dewars used to contain and cool superconducting coils (so that the coil or other components submerged/arranged within the volume of cryogenic liquid 230A can be accessed).

Another notable difference is that the liner member 230 is open-ended at the top, i.e., not a fully closed containment like the liner member 30 of the cryogenic vessel arrangement 100 of FIG. 2. The liner member 230 is arranged as such in this embodiment because the flask will not undergo movement or repetitive transport like a fuel storage tank such as the cryogenic vessel arrangement 100 might.

Thus, pressure equilibrium may be more easily maintained in this embodiment without the need for relief member(s), aperture(s), port(s), valve(s) or the like arranged on the liner member 230 as its internal pressure is inherently shared with that of the containment volume 228 (thus the absence of the liner member port 46 of FIG. 2).

However, the principal functions and features described in relation to the cryogenic vessel arrangement 100 of FIG. 2 nonetheless apply equally to this embodiment, where a liner member 230 is configured to receive and contain a cryogenic liquid 230A, wherein a thermal capacitance of the liner member 230 is substantially less than that of the inner wall 224 (via appropriate selection of liner member 230 thickness, material choice, and the like, as described above).

Thus, the liner member 230 here also may have a thermal capacitance configured so as to substantially reduce or inhibit the rate at which cryogenic vapours are released by the cryogenic liquid 230A upon its contact with, or receipt or storage by, the liner member 230; and/or configured so as to substantially reduce or inhibit the rate at which the temperature of the liner member 230 rises upon departure of cryogenic liquid 230A therefrom.

The above-mentioned considerations of the liner member 230, containment volume 228, insulation volume 226 in relation to the cryogenic vessel arrangement 100 of FIG. 2 also all may equally apply to this embodiment.

Thus, this embodiment cryogenic vessel arrangement 200 of FIG. 3 exemplifies an additional example of how one may apply the teachings of the cryogenic vessel arrangement described herein as a whole to different applications of cryogenic vessels.

Further, those skilled in the art may appreciate how the specific teachings of the liner member 30, 230 itself may be applied (i.e., retrofitted) to existing vessel arrangements, such as that of the prior art vessel of FIG. 1, wherein one may provide a cryogenic vessel liner 30, 230 for use in a cryogenic vessel 10, the liner 30, 230 configured to be located within a containment volume 12 of a cryogenic vessel 10 the periphery of which is defined by a vessel wall 14, wherein the liner 30, 230 is configured to receive and contain a cryogenic liquid and is configured to be spaced inwardly and apart from said vessel wall 14 in a manner so as to substantially reduce or inhibit contact of the cryogenic liquid with the containment volume 12 and/or vessel wall 14 in use, and wherein the liner 30, 230 has a thermal capacitance that substantially reduces or inhibits the rate at which cryogenic vapours are released by the cryogenic liquid upon its contact with, or receipt or storage by, the liner 30, 230 in use.

Further, the liner 30, 230, in use, may be configured with a thermal capacitance that substantially reduces or inhibits the rate at which the temperature of the liner 30, 230 rises upon departure of cryogenic liquid from the liner 30, 230; may have a thickness of at least about 0.5 mm to about 2 mm, or of about 1 mm to about 5 mm but may be less than 6 mm; may be supported from said vessel wall 14 by support member(s) that may be configured such that the liner 30, 230 is spaced apart from the vessel wall 14 at a distance that ranges from about 3 to about 20 times a thickness of the liner 30, 230; wherein the liner 30, 230 may be configured such that its thermal capacitance is substantially less than that of the vessel wall 14; wherein the liner 30, 230 may be configured with a thickness that ranges from at least about ⅓^{rd} to about 1/10^{th} of a thickness of the vessel wall 14 and/or wherein the liner 30, 230 may comprise at least one material selected from: metal, metal alloys, steel, steel alloys, aluminium, composites, fibreglass composites, fibreglass laminates, glass polymers, fibre-reinforced plastics and/or G-10 fibreglass laminate; and/or wherein the at least one material may have a thermal conductivity of about 0.25 W/m-K to about 240 W/m-K, or of about 0.288 W/m-K.

Embodiments of the invention have been described by way of example only and modifications may be made thereto without departing from the scope of the invention.

1-36. (canceled)

37. A cryogenic vessel arrangement for storage of cryogenic liquids, the arrangement comprising:
an outer wall defining an external periphery of the vessel arrangement;
an inner wall spaced inwardly from said outer wall so as to define therebetween an insulation volume of the vessel arrangement, wherein the inner wall defines a containment volume of the vessel arrangement internally of the inner wall; and
a liner member spaced inwardly and apart from the inner wall and located within said containment volume, the liner member configured to receive and contain a cryogenic liquid, wherein a thermal capacitance of the liner member is substantially less than that of the inner wall.

38. The cryogenic vessel arrangement of claim 37, wherein the thermal capacitance of the liner member is configured so as to substantially reduce or inhibit a rate at which cryogenic vapours are released by the cryogenic liquid upon its contact with, or receipt or storage by, the liner member.

39. The cryogenic vessel arrangement of claim 37, wherein the thermal capacitance of the liner member is configured so as to substantially reduce or inhibit a rate at which the temperature of the liner member rises upon departure of cryogenic liquid therefrom.

40. The cryogenic vessel arrangement of claim 37, wherein the liner member is configured with a thickness that ranges from about ⅓^{rd} to about 1/10^{th} of a thickness of the inner wall.

41. The cryogenic vessel arrangement of claim 37, wherein the inner wall has a thickness about 5 mm to about 10 mm; or a thickness of about 0.5 mm to about 2 mm.

42. The cryogenic vessel arrangement of claim 37, wherein the liner member comprises at least one material selected from: metal, metal alloys, steel, steel alloys, aluminium, composites, fibreglass composites, fibreglass laminates, glass polymers, fibre-reinforced plastics and/or G-10 fibreglass laminate.

43. The cryogenic vessel arrangement of claim 37, wherein the liner member comprises G-10 fibreglass laminate.

44. The cryogenic vessel arrangement of claim 37, wherein the liner member has a thermal conductivity that ranges from about 0.25 W/m-K to about 240 W/m-K.

45. The cryogenic vessel arrangement of claim 37, wherein the liner member has a thermal conductivity of about 0.288 W/m-K.

46. The cryogenic vessel arrangement of claim 37, wherein the liner member is configured to receive and contain the cryogenic liquid in a manner so as to substantially reduce or inhibit contact of the cryogenic liquid with the containment volume and/or inner wall.

47. The cryogenic vessel arrangement of claim 37, wherein the liner member is spaced apart from the inner wall and located within said storage volume by support member(s) that operatively connect said liner member to said inner wall.

48. The cryogenic vessel arrangement of claim 37, wherein the containment volume is configured to entrap at least some cryogenic vapours released by the cryogenic liquid upon its contact with, or receipt or storage by, the liner member.

49. The cryogenic vessel arrangement of claim 37, wherein the liner member and/or inner wall is/are configured such that the containment volume substantially maintains a pressure equilibrium between cryogenic liquids received or stored by the liner member and cryogenic vapours released by the cryogenic liquid upon its contact with, or receipt or storage by, the liner member.

50. The cryogenic vessel arrangement of claim 49, wherein said pressure equilibrium is substantially maintained via release, out from the containment volume, of at least some of said cryogenic vapours released by the cryogenic liquid upon its contact with, or receipt or storage by, the liner member.

51. The cryogenic vessel arrangement of claim 50, wherein said pressure equilibrium is substantially maintained via release, out from the containment volume, of at least some of said cryogenic vapours out from the liner member and/or containment volume by relief member(s) arranged at the inner wall and/or liner member.

52. The cryogenic vessel arrangement of claim 51, wherein said relief member(s) comprise(s) aperture(s), valve(s) and/or port(s).

53. The cryogenic vessel arrangement of claim 37, wherein the containment volume is configured to receive or store a gas maintained at substantially the same pressure as the cryogenic liquids received or stored by the liner member.

54. The cryogenic vessel arrangement of claim 37, wherein the insulation volume is configured to contain or comprises a vacuum and one or more insulative materials comprising multi-layer insulation, microspheres, polyester film(s), silk netting(s) and/or nylon netting(s).

55. The cryogenic vessel arrangement of claim 37, wherein the insulation volume is configured to have a surface area heat leak that ranges from at least about 0.5 W/m² to about 20 W/m².

56. A cryogenic vessel comprising the cryogenic vessel arrangement of claim 37.
